(19) United States
(12) Patent Application Publication
(10) Pub. No.: US 2007/0069862 A1
(43) Pub. Date: Mar. 29, 2007

(54) Apparatus and method for reading multiple tags with different protocols in RFID system

(76) Inventors: Hee-Sook Mo, Daejon (KR); Ji-Hoon Bae, Daejon (KR); Dong-Han Lee, Daejon (KR); Cheng-Hao Quan, Jilin Province (CN); Gil-Young Choi, Daejon (KR); Cheol-Sig Pyo, Daejon (KR); Jong-Suk Chae, Daejon (KR)

Correspondence Address: LADAS & PARRY LLP, 224 SOUTH MICHIGAN AVENUE, SUITE 1600, CHICAGO, IL, 60604, US

(21) Appl. No.: 11/525,310

(22) Filed: Sep. 22, 2006

(30) Foreign Application Priority Data
Sep. 23, 2005 (KR) 10-2005-0088930
Jun. 30, 2006 (KR) 10-2006-0061222

(51) Int. Cl. H04Q 5/22

(52) U.S. Cl. 340/10.2; 340/572.1; 340/10.1; 340/10.32

(57) ABSTRACT

An apparatus and method for reading multiple tags with different protocols in a RFID system are provided. The method of reading multiple tags with different protocols in a RFID system including the steps of: a) setting scheduling parameters including target protocols to read, priorities of each protocol, and information about a scheduling algorithm mode for reading multiple tags; b) reading tags of a single protocol corresponding to the target protocol when the scheduling algorithm mode is a single mode; and c) reading multiple tags by the target protocols when the scheduling algorithm mode is a multi mode.

### FIELD OF THE INVENTION

The present invention relates to an apparatus and method for reading multiple tags of different protocols in a Radio Frequency Identification (RFID) system.

### DESCRIPTION OF RELATED ARTS

A Radio Frequency Identification (RFID) system identifies a thin plane shaped tag attached at a product through a radio signal in non-contact manner and processes the related information thereof. The RFID system is formed of a RFID reader for reading and decoding, a RFID tag storing identification information and a network. The RFID tag includes a transponder chip made of a semiconductor and an antenna. The RFID tag is generally classified into a passive type tag that is driven by receiving energy from the radio signal transmitted from the RFID reader without having own power source, and an active type tag driven using power from own power source such as a battery. Also, the RFID tag is classified into a chip tag that includes a silicon semiconductor chip and a non-chip tag formed of only a LC circuit or plastic or polymer element. Furthermore, the RFID tag is classified into a read-only type and a read-write type according to the type of recording information. Recently, a RFID system with various frequency bands from a low frequency band lower than 150 KHz to a microwave band higher than 5 GHz has been commercialized. Related specifications for standardizing technologies for the RFID system have been defined, developed, and managed by IEC JTC1/SC31/WG4 in International standardization organization (ISO). The RFID system has been widely used in various application fields such as physical distribution, traffic control, security and safety system.

In case of identifying a target product by attaching a predetermined tag thereon, products with multiple tags using different protocols may be present with the target product in a same reader communication region. Practically, it frequently requires reading one product with multiple tags attached or reading a plurality of products with multiple tags attached rather than reading one product with a tag using a single protocol, that is, a single tag.

The most of the RFID readers support a single protocol only. Although a RFID reader supports the multiple tags with different protocols, the RFID reader requires complicated reading procedures to read multiple tags with different protocols. For example, a user manually sets the RFID reader to recognize a predetermined protocol of a tag. After setting, the RFID reader reads tags with the single protocol for a predetermined time. If a user wants to read tags with other protocol, the user must manually set the RFID reader again to read the tags with other protocol. Although the multiple tags with different protocols are automatically recognized, the RFID reader sequentially reads the multiple tags.

As described above, a RFID reader is capable of recognizing information about a product stored in a tag through a radio frequency band. Such a RFID reader has been developed dependently to a tag. That is, RFID readers must be developed according to tag protocol types. Although a RFID reader capable of reading multiple tags was introduced, the multiple tag reader requires the manual operation to change the protocol of tag to read. That is, the RFID reader cannot automatically change the protocols to read different tags.

When a plurality of RFID readers are installed according to the protocol types of tags, it requires an operator to regularly and manually set the operating mode of each RFID reader. It is very annoying process to the operator. Also, if the RFID readers are set differently, the RFID readers may be malfunctioned. Therefore, many difficulties may be arisen for operating and managing the RFID readers.

Meanwhile, as a conventional technology for automatically reading multiple tags with different protocols, a method for sequentially reading tags using a tag reading query regardless of the characteristics of protocols, communication states or application service. In this case, the wireless resources may be wasted.

### SUMMARY OF THE INVENTION

It is, therefore, an object of the present invention to provide a multi tag reading apparatus and method in a RFID system for automatically reading multiple tags with different protocols using a scheduling algorithm based on application service, communication state and tag properties after setting protocol types of multiple tags to support in the RFID system.

In accordance with an aspect of the present invention, there is provided a method of reading multiple tags with different protocols in a RFID system including the steps of: a) setting scheduling parameters including target protocols to read, priorities of each protocol, and information about a scheduling algorithm mode for reading multiple tags; b) reading tags of a single protocol corresponding to the target protocol when the scheduling algorithm mode is a single mode; and c) reading multiple tags by the target protocols when the scheduling algorithm mode is a multi mode, wherein the step c) includes the steps of: c-1) setting a reading time per each protocol according to the priority and reading multiple tags according to the reading time; and c-2) setting a reading time and a reading order by a protocol according to the priority, and reading multiple tags according to the reading time and the reading order.

In accordance with another aspect of the present invention, there is also provided a method of reading multiple tags in a RFID system including the steps of: a) setting scheduling parameters including target protocols to read, priorities of each protocol, and information about a scheduling algorithm mode for reading multiple tags; b) reading tags of a single protocol corresponding to the target protocol when the scheduling algorithm mode is a single mode; and c) setting a reading time by the target protocols according to the priority when the scheduling algorithm mode is a multi mode, and reading multiple tags by the target protocols according to the set reading time.

In accordance with still another aspect of the present invention, there is also provided a method of reading multiple tags with different protocols in a RFID system including the steps of: a) setting priorities of protocols of multiple tags to read; b) setting a reading time of each protocol according to the set priorities; and c) reading multiple tags of each protocol according to the reading time.

In accordance with further another aspect of the present invention, there is also provided a method of reading multiple tags with different protocols in a RFID system including the steps of: a) setting priorities of protocols of multiple tags to read; b) setting a reading time of each protocol according to the set priorities; c) setting a reading order for each protocol according to the set priorities; and d) reading multiple tags of each protocol according to the reading time.

In accordance with yet another aspect of the present invention, there is also provided an apparatus for reading multiple tags with different protocols in a RFID system including: a scheduling control unit for setting priorities of protocols of multiple tags to read and setting a reading time of each protocol according to the set priorities; and a multi tag reading unit for reading multiple tags of each protocol according to the reading time.

In accordance with yet still another aspect of the present invention, there is also provided an apparatus for reading multiple tags with different protocols in a RFID system including: a scheduling control unit for setting priorities of protocols of multiple tags to read and setting a reading time and a reading order of each protocol according to the set priorities; and a multi tag reading unit for reading multiple tags of each protocol according to the reading time and the reading order.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is block diagram illustrating a RFID system for reading multiple tags with different protocol in accordance with an embodiment of the present invention;

FIG. 2 is a block diagram illustrating a recognition controlling unit shown in FIG. 1;

FIG. 3 is a block diagram illustrating the structure of tag data according to an embodiment of the present invention;

FIG. 4 is a flowchart of a method for reading multiple tags with different protocols in accordance with an embodiment of the present invention;

FIG. 5 is a flowchart for describing a step for reading multiple tags according a first scheduling algorithm shown in FIG. 4;

FIG. 6 is a flowchart for describing a step for reading multiple tags according a second scheduling algorithm shown in FIG. 4;

FIG. 7 is a flowchart for describing a step for reading multiple tags according a third scheduling algorithm shown in FIG. 4;

FIG. 8 is a flowchart for describing a step for reading multiple tags according a fourth scheduling algorithm shown in FIG. 4; and

FIG. 9 is a timing diagram for reading multiple tags according to scheduling algorithm modes in the present invention.

### DETAILED DESCRIPTION OF THE INVENTION

Hereinafter, an apparatus and method for reading multiple tags with different protocol in a RFID system will be described in more detail with reference to the accompanying drawings.

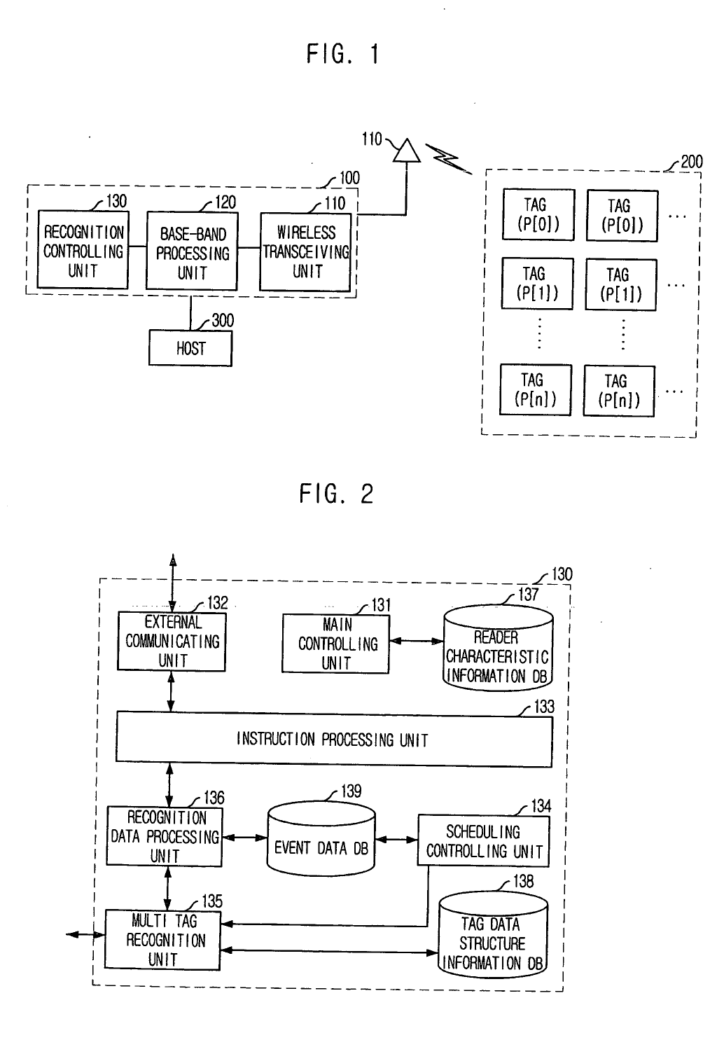

FIG. 1 is block diagram illustrating a RFID system for reading multiple tags with different protocol in accordance with an embodiment of the present invention.

Referring to FIG. 1, the RFID system according to the present embodiment includes a plurality of multi tags 200, a RFID reader 100 and a host 300. The plurality of multi tags 200 are a plurality of tags that use different types of protocols P[0], P[1], . . . , P[n]. The multi tags store the information of product by being attached at corresponding products and transmit the stored information through a wireless communication link. The RFID reader 100 reads tag data from the multi tags 200. The RFID reader 100 also stores and manages the read tag data, and transmits the tag data to the external host 300. The external host 300 remotely controls the RFID reader 100 by transmitting user's instructions through a wired/wireless communication link and processes the information received from the RFID reader 100.

The RFID reader 100 includes an antenna 110, a wireless transceiving unit 110 for communicating with the tag 200 through the antenna 100, a base-band processing unit 120 for detecting collision of received data from the tag 200, converting analog data received from the tag 200 to digital signal and outputting tag data, and a recognition controlling unit 130 for reading multiple tags with different protocols using various scheduling algorithms based on application service characteristics, communication states and tag properties by receiving the tag data.

FIG. 2 is a block diagram illustrating a recognition controlling unit shown in FIG. 1.

Referring to FIG. 2, the recognition controlling unit 130 of the RFID reader 100 according to the present embodiment includes a main controlling unit 131, an external communicating unit 132, an instruction processing unit 133, a scheduling controlling unit 134, a multi tag recognition unit 135, a recognition data processing unit 136, a reader characteristic information DB 137, a tag data structure information DB 138, and an event data DB. The main controlling unit 131 generally controls the RFID reader 100. The external communicating unit 132 performs necessary operations for communicating with the host 300. The instruction processing unit 133 analyzes instructions received from a user or the host 300 and processing the instructions according to the analysis result. The scheduling controlling unit 134 performs predetermined operations according to a scheduling algorithm for reading multiple tags and controls the multi tag recognition unit 135 according to the scheduling algorithm for reading multiple tags. The multi tag recognition unit 135 obtains the tag ID of a target protocol tag by driving a protocol processing module (not shown) to recognize a protocol tag according to a scheduling algorithm in response to the control of the scheduling controlling unit 134, and reads the tag data in corresponding to the obtained tag ID. The recognition data processing unit 136 stores and manages the tag data read from the multi tag recognition unit 135 and transmits the stored tag data to an external device. As databases storing units, the recognition controlling unit 130 includes a reader characteristic information DB 137, a tag data structure information DB 138, and an event data DB. The reader characteristic information DB 137 stores and manages reader characteristic information including the identification (ID) information, the communication mode and the scheduling parameter of a RFID reader. The tag data structure information DB 138 stores and manages information related to the data structure of a tag. The event data DB stores and manages scheduling information and tag reading information. Herein, the scheduling parameter will be described with reference to FIG. 4 in later.

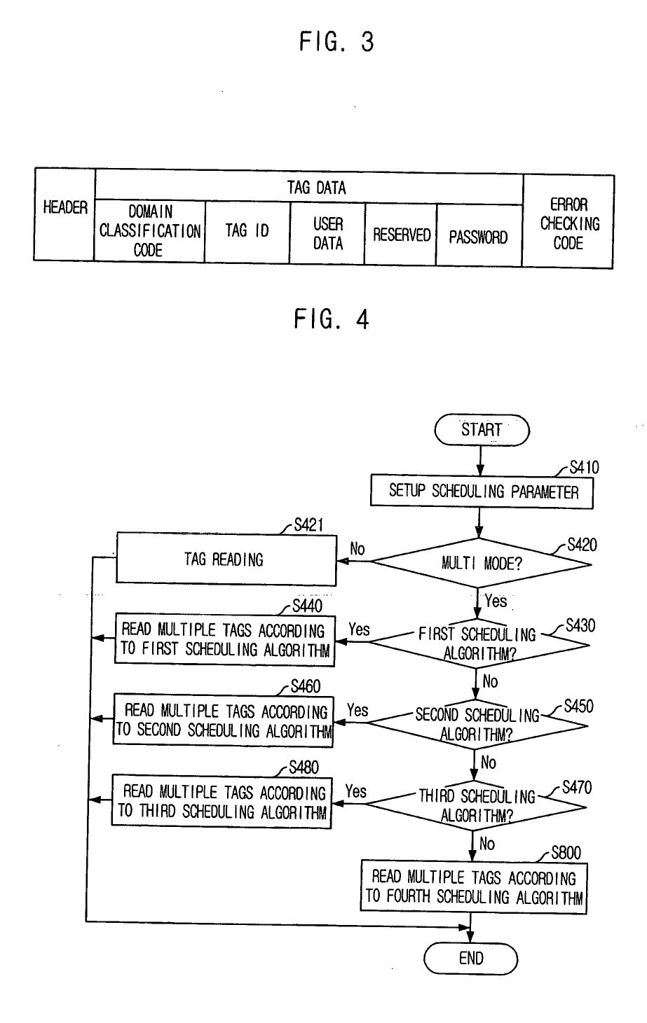

FIG. 3 is a block diagram illustrating the structure of tag data according to an embodiment of the present invention.

Referring to FIG. 3, the tag data includes a header field, a tag data field, and a tag error check code field.

The header field includes information that defines the length of a tag, the structure of a tag and the function of a tag.

The tag data field includes a domain classification code field denoting the type of a tag and the service field of a tag, a tag ID field for the classification information of a tag, a user data field for information about a service additionally defined by a service provider or the owner of a tag, a reserved field for additional use and a password field for security purpose.

The error check code field is used to check the validity of received tag data.

In case of a tag to be attached at a product, for example, the user data field may store information about the term of validity provided from a product manufacturer or addition information defined by a seller of a product for managing the product such as location. Also, the tag ID field may store the information of the product manufacturer and the tag ID information. The domain classification field may include information for managing stocks, information for service location such as grocery department or living goods department, manufacturer information, information about application field, cart classification, a cart ID and an ID flag.

FIG. 4 is a flowchart of a method for reading multiple tags with different protocols in accordance with an embodiment of the present invention.

At first, a scheduling parameter is set at step S410. The scheduling parameter is set through initializing the scheduling parameter by reading scheduling parameter values stored in the reader characteristic DB 137 when the RFID reader is booted. Or, a user sets the scheduling parameter values through interaction with the host.

The scheduling parameter includes a protocol P[i] to recognize, the number of protocols nP to read, a query unit time per a protocol Qt[i], a priority per a protocol V[i], a minimum read rate R, a minimum receiving signal level S and a scheduling algorithm mode AL-x.

The scheduling algorithm mode is mainly classified into a single mode (AL-0) and a multi mode (AL-1, AL-2, and AL-3). The single mode AL-0 is a mode of reading a tag with single protocol. Accordingly, a read cycle time (RCT) becomes a query unit time of a corresponding protocol. The multi mode includes a first scheduling algorithm mode AL-1, a second scheduling algorithm mode AL-2, a third scheduling algorithm mode AL-3, and a fourth scheduling algorithm mode AL-4.

The first scheduling algorithm mode AL-1 reads multiple tags by scheduling multiple tags according to the same read cycle time (RCT) per a protocol. The second scheduling algorithm mode AL-2 reads multiple tags by setting the RCTs of each protocol differently according to the priority PV[i]. In the present embodiment, the RCT is an n time of a query unit time of each protocol. The higher the priority is, the larger the RCT becomes. The third scheduling algorithm AL-3 reads the multiple tags by setting a RCT and a reading order of each protocol differently according the priority V[i]. The fourth scheduling algorithm AL-4 differently sets a RCT and a reading order of each protocol according to the priority V[i], and schedules the multiple tags to read while reading the multiple tags by reflecting the number of read tags per a protocol, the read rate and the receiving signal level.

After setting the scheduling parameter at step S410, it determines whether the scheduling algorithm mode is a multi mode or not at step S420.

If the scheduling algorithm mode is not the multi mode at step S410, tags of a protocol type P[i] are read in a corresponding query unit time Qt[i] at step S421. Herein, if the scheduling algorithm mode is the single mode, it sets only one protocol parameter P[i] to read.

On the contrary, if the scheduling algorithm mode is the multi mode at step S410, it determines whether a scheduling algorithm mode is a first scheduling algorithm mode AL-1 or not at step S430.

If the scheduling algorithm mode is a first scheduling algorithm mode AL-1 at step S430, the multiple tags of protocols P[i] are read according to the first scheduling algorithm at step S440. If the scheduling algorithm mode is not a first scheduling algorithm mode AL-1 at step S430, it determines whether a scheduling algorithm mode is a second scheduling algorithm mode AL-2 or not at step S450.

If the scheduling algorithm mode is the second scheduling algorithm mode AL-2 at step S450, the multiple tags of protocols P[i] are read according to the second scheduling algorithm at step S460. If the scheduling algorithm mode is not the second scheduling algorithm mode AL-2 at step S450, it determines whether a scheduling algorithm mode is a third scheduling algorithm mode AL-3 or not at step S470.

If the scheduling algorithm mode is the third scheduling algorithm mode AL-3 at step S470, the multiple tags of protocols P[i] are read according to the third scheduling algorithm at step S480. If the scheduling algorithm mode is not the third scheduling algorithm mode AL-3 at step S470, the multiple tags of protocols P[i] are read according to the fourth scheduling algorithm at step S800.

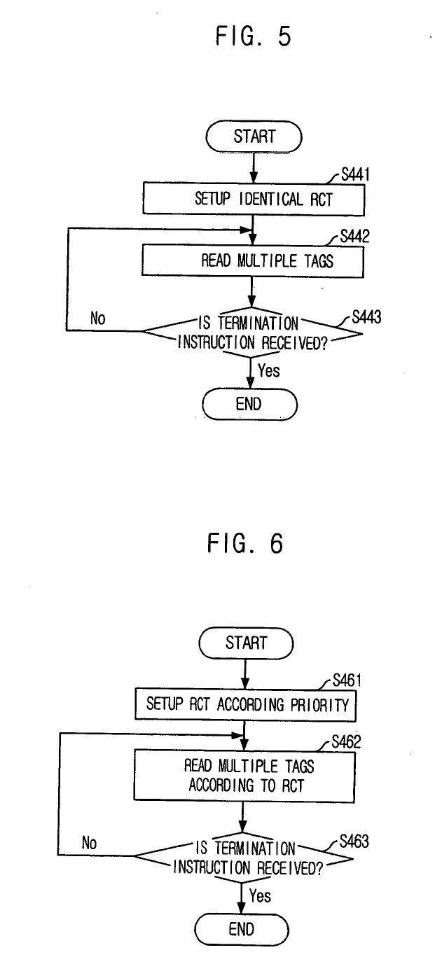

FIG. 5 is a flowchart for describing a step for reading multiple tags according a first scheduling algorithm shown in FIG. 4.

Referring to FIG. 5, it sets the RCTs of each protocol to recognize identically at step S441.

Then, it reads multiple tags of each protocol according to the identical set RCT at step S442.

Then, it determines whether a termination instruction is received from a host or not at step S443. If the termination instruction is received, the tag reading is terminated.

FIG. 6 is a flowchart for describing a step for reading multiple tags according a second scheduling algorithm shown in FIG. 4.

At first, it sets the RCTs of each protocol to recognize according to a priority using below Eq. 1 at step S461.
For(i=0; i<nP; i++){RCT[i]=Qt[i]*(nP−Y[ib]+1)} Eq. 1

For example, it assumes that the number of protocols to recognize (nP) is 4, the priority Y[0] of the first type protocol P[0] is 1, the priority Y[1] of the second type protocol P[1] is 3, the priority Y[2] of the third type protocol P[2] is 4, and the priority Y[3] of the fourth type protocol P[3] is 2.

Since the RCT [0] which is a RCT of tags using the first type protocol having the highest priority 1 is Qt[O]*(nP−Y[0]+1), the RCT[0] becomes 4*Qt[0] due to Qt[0]*(4−1+1). Therefore, the RCT of tags using the first type protocol becomes four times of the query unit time of the first type protocol.

The RCT [3] of the fourth type protocol P[3] having the second highest priority becomes 3*Qt[3], the RCT [1] of the second type protocol P[1] becomes 2*Qt[1], and the RCT [2] of the third type protocol P[2] becomes 2*Qt[2].

Therefore, the protocol having the highest priority has the longest RCT according to the present embodiment.

After setting the RCT at step S461, it reads multiple tags of each protocol according to the set RCT at step S462.

Then, it determines whether a termination instruction is received or not from a host at step S463. It the termination instruction is received, the multiple tag reading is terminated.

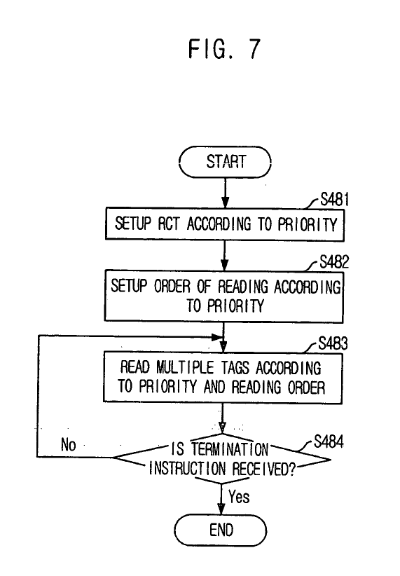

FIG. 7 is a flowchart for describing a step for reading multiple tags according a third scheduling algorithm shown in FIG. 4.

At first, the RCTs of each protocol to recognize are set according to the priority of each protocol using Eq. 1 at step S481.

Then, the reading order of protocols is set according to the priority at step S482. In the present embodiment, the reading order is set by arranging protocols from one having the highest priority to one having the lowest priority.

Then, it reads multiple tags according to the arranged protocol reading order, that is, according to the RCTs and the reading order of each protocol, at step S483.

Then, it determines whether a termination instruction is received or not from a host at step S483. It the termination instruction is received, the multiple tag reading is terminated.

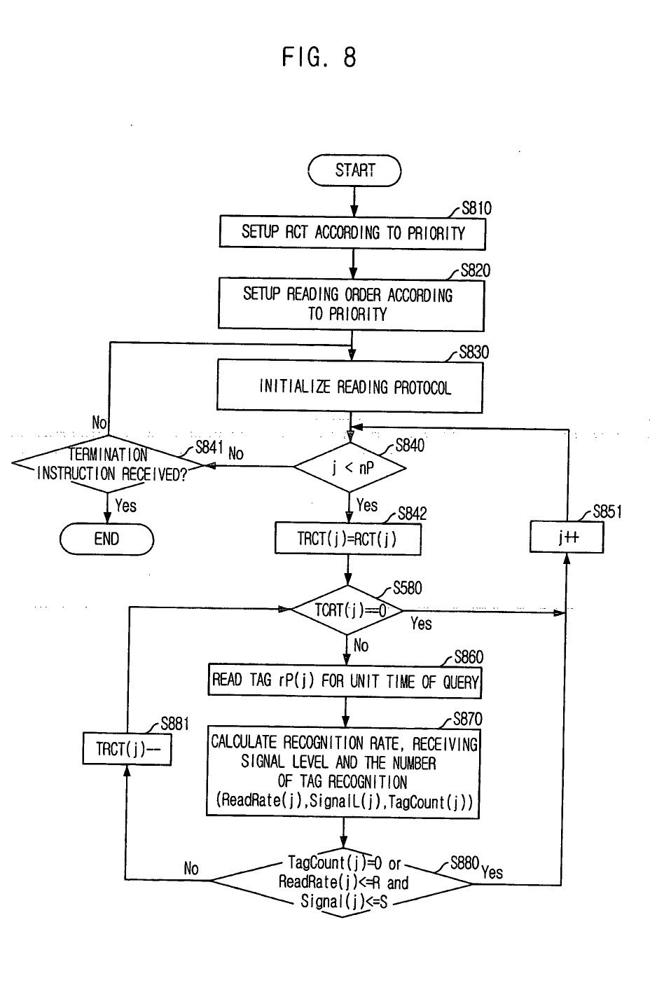

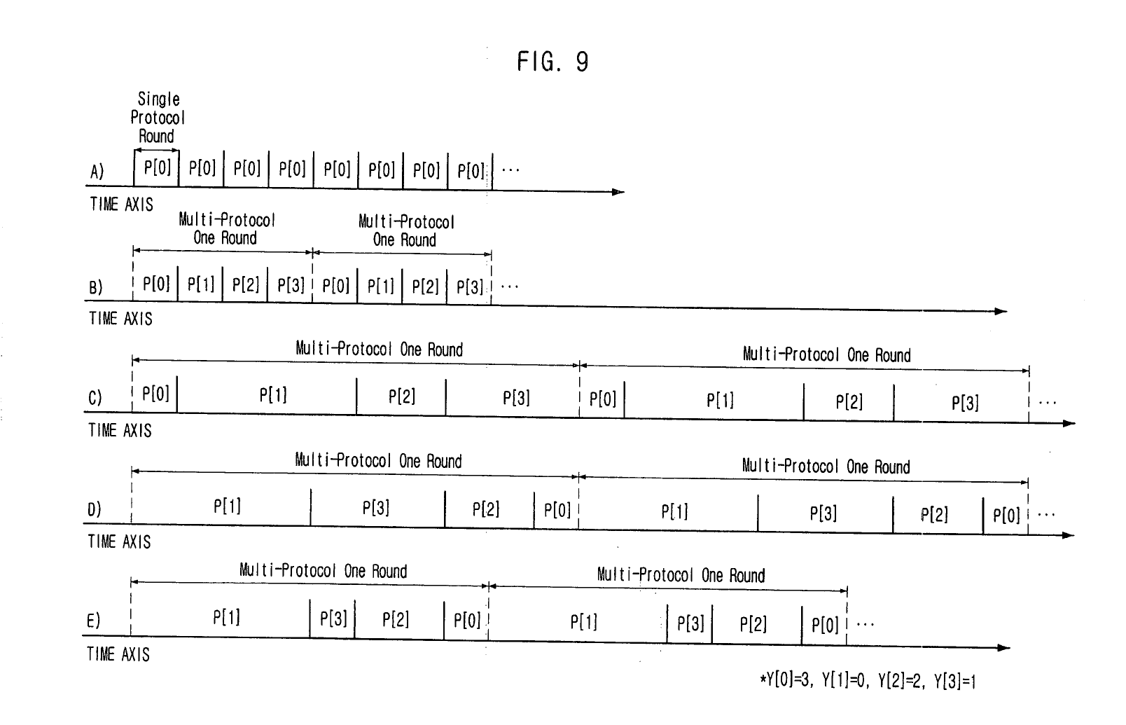

FIG. 8 is a flowchart for describing a step for reading multiple tags according a fourth scheduling algorithm shown in FIG. 4.

At first, the RCTs of each protocol are set according to the priorities of protocols using Eq. 1 at step S881.

Then, it sets a protocol reading order according to a priority at step S820. In the present embodiment, the reading order is set by arranging the reading protocols rP(j). Herein, rP(j) denotes a protocol having a (j+1)^{th} priority. For example, a protocol having the highest priority is set as rP(0) and a protocol having the second highest priority is set as rP(1). That is, a reading protocol is set according to the priority.

Then, the reading protocol is initialized by initializing a variable j that denotes the reading protocol order to 0 at step S830.

Then, it determines whether j is smaller than the number of protocols (np) at step S840.

If j is equal to or larger than the number of protocols (np) at step S840, it determines that all reading procedures for the set protocols are already performed. At step S841, it determines whether the termination instruction is received from a user or not at step S841.

If the termination instruction is not received at step S841, the step S830 is performed to repeatedly perform the multiple tag reading procedure. If the termination instruction is received at step S841, the multiple tag reading procedure is terminated.

Meanwhile, if j is smaller than the number of protocols (nP) at step S840, it reads tags of protocols rP(j) having the (j+1)^{th} priority according to the read rate, the signal level and the number of tags.

That is, the RCT value (RCT(j)) of the protocol having the (j+1)^{th} priority is set to a temporal RCT (TRCT(j)) at step S842, and it determines whether TRCT(j) is 0 or not at step S850.

If TRCT(j) is 0 at step S850, the tag reading procedure of the corresponding reading protocol is terminated because the RCT for the corresponding reading protocol is not left. Then, j increases by 1 for reading the tag of a protocol having the next priority at step S851, and the step S840 is performed again.

On the contrary, if TRCT(j) is not 0 at step S850, it reads the tags of rP(j) for the query unit time of a corresponding reading protocol at step S860.

Then, it calculates the read rate (ReadRate(j)), the receiving signal level (signal(j)) and a tag reading count (TagCount(j)) of the corresponding reading protocol tags based on the reading result at step S870.

Then, it determines whether the calculated read rate (j) is smaller than the set minimum read rate (R), the calculated Signal(j) is the set minimum receiving signal level (S) or the tag reading count (TagCount(j)) is 0 or not at step S860.

If the calculated read rate (ReadRate (j)) is smaller than the minimum read rate (R), the Signal (j) is smaller than the minimum receiving signal level, or the tag reading count (TagCount(j)) is 0 at the step S860, the step S851 is performed to terminate the multiple tag reading at step S890 regardless of the remained tag reading time of corresponding reading protocol.

Meanwhile, if the calculated read rate (ReadRate (j)) is larger than the minimum read rate (R), the Signal (j) is larger than the minimum receiving signal level, or the tag reading count (TagCount(j)) is not 0 at the step S860, TRCT(j) is reduced as much as the query unit time, and the step S850 is performed at step S881.

FIG. 9 is a timing diagram for reading multiple tags according to scheduling algorithm modes in the present invention.

The timing diagram (A) of FIG. 9 is for reading a single protocol tag P[O] when the scheduling algorithm is a single mode.

The timing diagram B) of FIG. 9 is for reading multiple tags according to the first scheduling algorithm. That is, tags with four types of protocols are read with the same RCT according to the first scheduling algorithm.

The timing diagram C) of FIG. 9 is for reading multiple tags according to the second scheduling algorithm. That is, tags with four types of protocols P{0}, P[1], P[2], and P[3] are read by setting a RCT according to predetermined priorities (Y[0]=3, Y[1]=0, Y[2]=2, Y[3]=1) in the second scheduling algorithm.

The timing diagram D) of FIG. 9 is for reading multiple tags according to the third scheduling algorithm. That is, 0tags with four types of protocols P{0}, P[1], P[2], and P[3] are read by setting a RCT and a reading order according to predetermined priorities (Y[0]=3, Y[1]=0, Y[2]=2, Y[3]=1) in the third scheduling algorithm.

The timing diagram E) of FIG. 9 is for reading multiple tags according to the fourth scheduling algorithm. That is, tags with four types of protocols P{0}, P[1], P[2], and P[3] are read by setting a RCT and a reading order according to predetermined priorities (Y[0]=3, Y[1]=0, Y[2]=2, Y[3]=1) according to the fourth scheduling algorithm, and the RCTs adeptly change according to a read rate (ReadRate(j)), a receiving signal level (Signal(j)) and a tag reading count (TagCount(j)) while reading the multiple tags.

In the present embodiment, P[2] denotes a case of not recognizing the tag of a corresponding protocol after a first query unit time or a case of bad communication state, that is, the reading rate, and the receiving signal level are lower than a predetermined threshold.

Although the RCT is set to 3*Qt[2] because the P[2] protocol has the second highest priority, the tag reading is no longer performed and the reading of next protocol tags is performed if no tag is read or the communication state is bad. Therefore, more resources are allocated to tags of corresponding protocol having good communication state.

As described above, the RFID reader according to the present invention can read multiple tags with different protocols through scheduling multiple tags by protocols according to predetermined parameters.

Also, the RFID reader according to the present invention can be remotely controlled through a network, and is capable of selecting the protocol type to read according to the type of application service. Therefore, efficiency of using resources can be improved by blocking unnecessary trail of reading the protocol tag.

Furthermore, the RFID reader according to the present invention can read tags using various protocols. Therefore, it does not require a plurality of RFID readers for different protocols to install. That is, a RFID system cost for installing and managing can be reduced.

Moreover, a cost for developing the RFID system also can be reduced because it does not require software to develop according to the types of protocols.

The present application contains subject matter related to Korean Patent Application Nos. 10-2005-0088930 and 10-2006-0061222, filed with the Korean patent office on Sep. 23, 2005, and Jun. 30, 2006, the entire contents of which being incorporated herein by reference.

While the present invention has been described with respect to certain preferred embodiments, it will be apparent to those skilled in the art that various changes and modifications may be made without departing from the spirits and scope of the invention as defined in the following claims.

What is claimed is:

1. A method of reading multiple tags with different protocols in a RFID system, comprising the steps of:
a) setting scheduling parameters including target protocols to read, priorities of each protocol, and information about a scheduling algorithm mode for reading multiple tags;
b) reading tags of a single protocol corresponding to the target protocol when the scheduling algorithm mode is a single mode; and
c) reading multiple tags by the target protocols when the scheduling algorithm mode is a multi mode,
wherein the step c) includes the steps of:
c-1) setting a reading time per each protocol according to the priority and reading multiple tags according to the reading time; and
c-2) setting a reading time and a reading order by a protocol according to the priority, and reading multiple tags according to the reading time and the reading order.

2. The method as recited in claim 1, wherein the step c) further includes the step of: setting a tag reading time and a reading order of each protocol according to the priority, and
canceling a remained reading time and reading tags of a next protocol if a tag of a corresponding protocol is not recognized for a query unit time of the corresponding protocol while reading multiple tags by protocols according to the reading time.

3. The method as recited in claim 1, wherein the step c) further includes the step of: canceling a remained reading time and reading tags of a next protocol if a receiving signal level of a corresponding protocol tag received for a query unit time of the corresponding protocol is smaller than a predetermined minimum receiving signal level while reading multiple tags by a protocol according to the reading time.

4. The method as recited in claim 1, wherein the step c) further includes the step of: canceling a remained reading time and reading tags of a next protocol if a read rate of a corresponding protocol tag received for a query unit time of the corresponding protocol is smaller than a predetermined minimum read rate while reading multiple tags by a protocol according to the reading time.

5. A method of reading multiple tags in a RFID system comprising the steps of:
a) setting scheduling parameters including target protocols to read, priorities of each protocol, and information about a scheduling algorithm mode for reading multiple tags;
b) reading tags of a single protocol corresponding to the target protocol when the scheduling algorithm mode is a single mode; and
c) setting a reading time by the target protocols according to the priority when the scheduling algorithm mode is a multi mode, and reading multiple tags by the target protocols according to the set reading time.

6. The method as recited in claim 5, wherein in the step c), a remained reading time is cancelled and tags of a next protocol are read if a tag of a corresponding protocol is not recognized for a query unit time of the corresponding protocol while reading multiple tags by protocols according to the reading time.

7. The method as recited in claim 5, wherein in the step c), a remained reading time is cancelled and tags of a next protocol are read if a receiving signal level of a corresponding protocol tag received for a query unit time of the corresponding protocol is smaller than a predetermined minimum receiving signal level while reading multiple tags by a protocol according to the reading time.

8. The method as recited in claim 5, wherein in the step c), a remained reading time is cancelled and tags of a next protocol are read if a read rate of a corresponding protocol tag received for a query unit time of the corresponding protocol is smaller than a predetermined minimum read rate while reading multiple tags by a protocol according to the reading time.

9. A method of reading multiple tags with different protocols in a RFID system, comprising the steps of:
a) setting priorities of protocols of multiple tags to read;
b) setting a reading time of each protocol according to the set priorities; and
c) reading multiple tags of each protocol according to the reading time.

10. The method as recited in claim 9, wherein the reading time is set to predetermined times of a query unit time of a corresponding protocol and the predetermined times is decided by the priority.

11. The method as recited in claim 10, wherein the reading time is set based on an equation:
For(i=0; i<nP; i++){RCT[i]=Qt[i]*(nP−Y[i]+1)}
wherein nP denotes the number of target protocols to read, RCT[i] denotes the reading time of a (i-1)^{th} type protocol, Qt[i] is the query unit time of a (i-1)th type protocol, and Y[i] denotes the priority of a (i-1)th type protocol.

12. The method as recited in claim 9, wherein in the step c), a remained reading time is cancelled and tags of a next protocol are read if a tag of a corresponding protocol is not recognized for a query unit time of the corresponding protocol while reading multiple tags by protocols according to the reading time.

13. The method as recited in claim 9, wherein in the step c), a remained reading time is cancelled and tags of a next protocol are read if a receiving signal level of a corresponding protocol tag received for a query unit time of the corresponding protocol is smaller than a predetermined minimum receiving signal level while reading multiple tags by a protocol according to the reading time.

14. The method as recited in claim 9, wherein in the step c), a remained reading time is cancelled and tags of a next protocol are read if a read rate of a corresponding protocol tag received for a query unit time of the corresponding protocol is smaller than a predetermined minimum read rate while reading multiple tags by a protocol according to the reading time.

15. A method of reading multiple tags with different protocols in a RFID system comprising the steps of:
a) setting priorities of protocols of multiple tags to read;
b) setting a reading time of each protocol according to the set priorities;
c) setting a reading order for each protocol according to the set priorities; and
d) reading multiple tags of each protocol according to the reading time.

16. The method as recited in claim 15, wherein the reading time is set to predetermined times of a query unit time of a corresponding protocol and the predetermined times is decided by the priority.

17. The method as recited in claim 15, wherein in the step d), a remained reading time is cancelled and tags of a next protocol are read if a tag of a corresponding protocol is not recognized for a query unit time of the corresponding protocol while reading multiple tags by protocols according to the reading time.

18. The method as recited in claim 15, wherein in the step d), a remained reading time is cancelled and tags of a next protocol are read if a receiving signal level of a corresponding protocol tag received for a query unit time of the corresponding protocol is smaller than a predetermined minimum receiving signal level while reading multiple tags by a protocol according to the reading time.

19. The method as recited in claim 15, wherein in the step d), a remained reading time is cancelled and tags of a next protocol are read if a read rate of a corresponding protocol tag received for a query unit time of the corresponding protocol is smaller than a predetermined minimum read rate while reading multiple tags by a protocol according to the reading time.

20. An apparatus for reading multiple tags with different protocols in a RFID system comprising:
a scheduling control unit for setting priorities of protocols of multiple tags to read and setting a reading time of each protocol according to the set priorities; and
a multi tag reading unit for reading multiple tags of each protocol according to the reading time.

21. The apparatus as recited in claim 20, wherein the reading time is set to predetermined times of a query unit time of a corresponding protocol and the predetermined times is decided by the priority.

22. The apparatus as recited in claim 20, wherein the reading time is set based on an equation:
For(i=0; i<nP; i++){RCT[i]=Qt[i]*(nP−Y[i]+1)}
wherein nP denotes the number of target protocols to read, RCT[i] denotes the reading time of a (i-1)^{th} type protocol, Qt[i] is the query unit time of a (i-1)th type protocol, and Y[i] denotes the priority of a (i-1)th type protocol.

23. The apparatus as recited in claim 20, wherein the multi tag reading unit cancels a remained reading time and reads tags of a next protocol if a tag of a corresponding protocol is not recognized for a query unit time of the corresponding protocol while reading multiple tags by protocols according to the reading time.

24. The apparatus as recited in claim 20, wherein the multi tag reading unit cancels a remained reading time and reads tags of a next protocol if a receiving signal level of a corresponding protocol tag received for a query unit time of the corresponding protocol is smaller than a predetermined minimum receiving signal level while reading multiple tags by a protocol according to the reading time.

25. The apparatus as recited in claim 20, wherein the multi tag reading unit cancels a remained reading time and reads tags of a next protocol if a read rate of a corresponding protocol tag received for a query unit time of the corresponding protocol is smaller than a predetermined minimum read rate while reading multiple tags by a protocol according to the reading time.

26. An apparatus for reading multiple tags with different protocols in a RFID system comprising:
a scheduling control unit for setting priorities of protocols of multiple tags to read and setting a reading time and a reading order of each protocol according to the set priorities; and
a multi tag reading unit for reading multiple tags of each protocol according to the reading time and the reading order.

27. The apparatus as recited in claim 26, wherein the multi tag reading unit cancels a remained reading time and reads tags of a next protocol if a tag of a corresponding protocol is not recognized for a query unit time of the corresponding protocol while reading multiple tags by protocols according to the reading time.

28. The apparatus as recited in claim 26, wherein the multi tag reading unit cancels a remained reading time and reads tags of a next protocol if a receiving signal level of a corresponding protocol tag received for a query unit time of the corresponding protocol is smaller than a predetermined minimum receiving signal level while reading multiple tags by a protocol according to the reading time.

29. The apparatus as recited in claim 26, wherein the multi tag reading unit cancels a remained reading time and reads tags of a next protocol if a read rate of a corresponding protocol tag received for a query unit time of the corresponding protocol is smaller than a predetermined minimum read rate while reading multiple tags by a protocol according to the reading time.
